(19) United States
(12) Patent Application Publication
(10) Pub. No.: US 2014/0327773 A1
(43) Pub. Date: Nov. 6, 2014

(54) AUTOMOTIVE SECURITY SYSTEM

(71) Applicant: Ilectra Scott-Cook, Bronx, NY (US)

(72) Inventor: Ilectra Scott-Cook, Bronx, NY (US)

(21) Appl. No.: 14/269,053

(22) Filed: May 2, 2014

Related U.S. Application Data
(60) Provisional application No. 61/818,867, filed on May 2, 2013.

(51) Int. Cl. H04N 7/18

(52) U.S. Cl. CPC H04N 7/183; B60R 2300/8073
USPC 348/148

(57) ABSTRACT

An automotive security system enables users to remotely monitor their vehicles with the system providing a complete, recorded view of the interior and exterior of the car, while at the same time offering a remote alert that their car's security has been breached. The system comprises a 360 degree rotating camera mounted in the vehicle and a remote handheld, companion video monitor receiving s and control system for viewing and receiving an audible signal.

### CLAIM OF PRIORITY

This patent application claims priority under 35 USC 119 (e) (1) from U.S. Provisional Patent Application Ser. No. 61/818,867 filed May 2, 2013, of common inventorship herewith entitled, “Automotive Security System.”

### BACKGROUND OF THE INVENTION

1. Field of the Invention

This invention relates generally to an automotive security system and, more particularly, the invention relates to an automotive security system providing a camera/recorder system for automotive vehicles comprised of a digital camera, placed at a vantage point within the vehicle, working in conjunction with a handheld, companion video monitor and control system.

2. Description of the Prior Art

One of the most attractive luxuries to would-be thieves and intruders is the automobile. Thieves find unattended vehicles to be easy marks for speedy thrills and quick cash. To combat this crime, automakers have begun offering already-installed security systems as a standard option on new cars. In addition, owners of older automobiles are choosing to outfit their cars with alarms to protect their valuable property.

While automobile security systems can be effective deterrents to possible larceny, these devices are not completely infallible. Particularly, crafty and enterprising criminals, wise to the configuration of car alarms, may possess the technical knowledge required to circumvent the most intricate of auto security systems. With something as simple as the snip of a wire, a smart thief may be able to disable an alarm's audible siren. In a matter of minutes, a car or the valuables inside can be swiped with the owner being none the wiser.

### BRIEF DESCRIPTION OF THE DRAWINGS

FIGS. 1 and 2 are perspective views illustrating an automotive security system, constructed in accordance with the present invention.

### DETAILED DESCRIPTION OF THE PREFERRED EMBODIMENTS

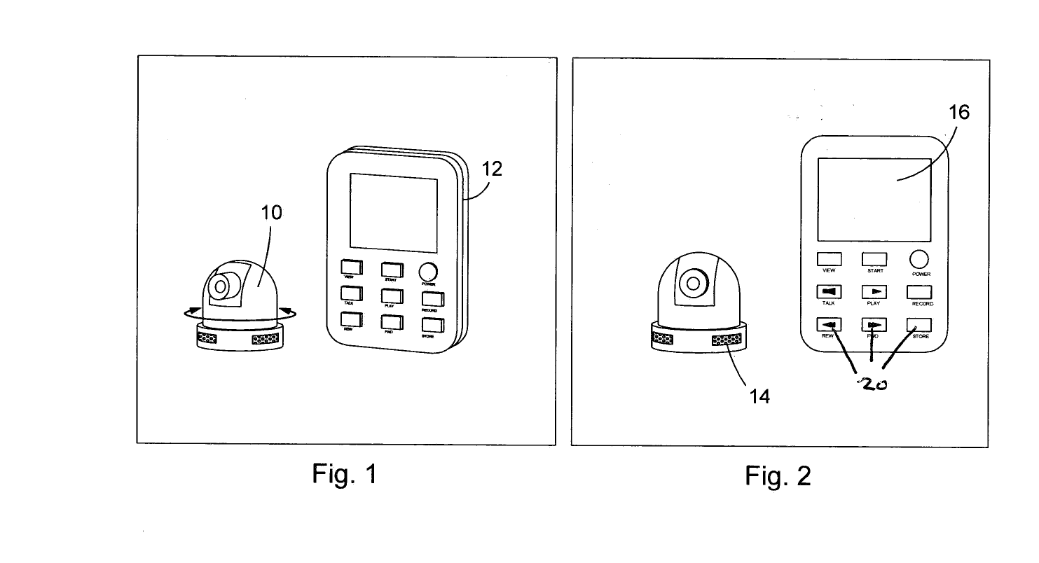

As illustrated in FIGS. 1 and 2, the present invention is an automotive security system providing a camera/recorder system for automotive vehicles comprised of a digital camera 10, placed at a vantage point within the vehicle, working in conjunction with a handheld, companion video monitor 12 and control system.

The automotive security system of the present invention enables users to remotely monitor their vehicles with the system providing a complete, recorded view of the interior and exterior of the car, while at the same time offering a remote alert that their car's security has been breached. Retrofitted into existing automobiles or incorporated at time of manufacture, the system's camera 10 can each be a compact, digital model, with at least 2 to 3 megapixel resolution. Outfitted with a sensor mechanism 14 that activates the system should someone other than the owner approach the vehicle, the transmitting camera 10 sends recorded images, along with an audio alert, to the remotely controlled receiver 12. Equipped with a liquid crystal display 16 (LCD) to display images, the rectangular receiver 12 also features a series of operational buttons 20 to allow for operational aspects such as system programming, remote camera adjustment, and a voice transfer component that allows an owner to verbally confront a would-be intruder from the safety of a remote location. Additionally, the remote receiver 12 includes copious capacity for saving and storing the recorded images for up to 24 hours, and can be configured for voice activation along with manual input. It also allows the owner to store and save the captured images until they delete them. If not stored and saved after the 24 hour period, the images will automatically be deleted. The system employs the use of highly sophisticated equipment integrated with software that enables the system to record everything that happens from the camera system, which is configured to rotate a full 360 degrees to ensure coverage of the front, back, and both sides of the vehicle, both inside and outside. As such, when the sensor 14 in the camera 10 detects a presence, it generates and transmits a signal. The companion receiving unit 12 is tuned to the specific frequency generated by the transmitter unit. Upon reception of the signal generated by the transmitter, the circuitry in the receiver generates an “enable” signal to a logic device (an “AND” integrated circuit chip or comparable) which applies a voltage level to the remote receiver unit, causing it to be activated. The receiver 12 then emits a continuous audible sound and display the images recorded by the transmitting camera 10. The user is able to see who is at the vehicle, and can then press the appropriate buttons 20 for storing the images and speaking to the intruder. The system can have a voice command preprogrammed to emanate from the camera in the car itself, vocally informing anyone with nefarious intent that he is being watched and recorded.

The automotive security system affords users several significant benefits and advantages. Foremost, the system provides an instant warning to car owners that the security of their automobile has been violated, even if the car alarm siren has been disabled. Offering users added protection against artful and cunning thieves, the system easily foils any attempts to break into a vehicle without detection. Seeing a vehicle adorned with sophisticated camera equipment, along with hearing a voice of warning, would-be thieves and vandals and any other ne'er-do-well will certainly think twice about victimizing this motorist or their property. In this manner, auto owners gain a valuable aid in the fight against vehicle larceny. Compact and lightweight, the handheld, remote control and video monitor can be comfortably carried in a pocket or purse, allowing users to transport their car's security system wherever they may go. Whether watching TV at home, shopping in the mall, or stuck working in the office, the system provides uses with immediate notification that an intruder has entered their unattended vehicle, with complete video coverage of the perpetrator. As a result, users can effectively avoid the high-cost hassle of a stolen car or the expensive replacement of valuable accessories and contents. The recording of the perpetrator's image also greatly assists in identification and possible arrest and prosecution. Not just for vehicle theft and vandalism, the system proves invaluable in the event of a hit-and-run incident. Capturing the images of the assailing vehicle, the camera helps identify such criminals that cause millions of dollars in damages each year. Eliminating the need for a blaring siren, the Catcher system effectively reduces noise pollution. In this manner, neighboring households are not disturbed should the alarm go off in the middle of the night. Additionally, users do not have to interrupt any activities to check if an alarm is coming from their vehicle, as opposed to a neighbor who has a similar-sounding alert. As such, the system guards against “false” alarms, which occurs often and results in users ignoring some warnings, since users are able to actually see what is going on around the vehicle and can reset the system if no problems are detected.

The automotive security system of the present invention provides car owners with confidence and peace of mind. Utilizing the latest security technology, the remote warning device proves an invaluable accent to existing car security systems.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. An automotive security system comprising:
automotive security system providing a camera and recorder system for automotive vehicles comprised of a digital camera, placed at a vantage point within the vehicle, further comprising a remote handheld, companion video monitor receiving and control system.

2. The automotive security system of claim 1 wherein the camera is a compact, digital camera, with at least 2 to 3 megapixel resolution.

3. The automotive security system of claim 1, further comprising a sensor mechanism mounted on or near the camera, wherein the sensor activates the system if someone other than the owner approaches the vehicle, wherein the activation comprises transmitting recorded images, and an audio alert, to the remote handheld companion video monitor receiving and control system.

4. The automotive security system of claim 1 wherein the remote handheld companion video monitor receiving and control system comprises a liquid crystal display (LCD) to display images.

5. The automotive security system of claim 1 wherein the remote handheld companion video monitor receiving and control system further comprises operational buttons to allow for operational aspects such as system programming, remote camera adjustment, and a voice transfer component that allows an owner to verbally confront a would-be intruder from the safety of a remote location.

6. The automotive security system of claim 1 wherein the remote handheld companion video monitor receiving and control system further comprises capacity for saving and storing recorded images.

7. The automotive security system of claim 1 wherein the remote handheld companion video monitor receiving and control system can be configured for voice activation and for manual input.

8. The automotive security system of claim 6 wherein the remote handheld companion video monitor receiving and control system deletes images after 24 hours.

9. The automotive security system of claim 6 wherein the remote handheld companion video monitor receiving and control system saves images until deleted by the user.

10. The automotive security system of claim 1 wherein the camera is capable of rotating 360 degrees to ensure coverage of the front, back, and both sides of the vehicle, both inside and outside.

11. The automotive security system of claim 3, wherein activation comprises detecting a presence, generating and transmitting a signal to the remote handheld companion video monitor receiving and control system, wherein the receiving system is tuned to a specific frequency generated by the transmitter, further wherein reception of the signal generates an “enable” signal to a logic device (an “AND” integrated circuit chip or comparable) which applies a voltage level to the remote receiver system, causing it to be activated, further wherein the receiving system emits a continuous audible sound and displays the images recorded by the camera.

12. The automotive security system of claim 11, further wherein the displayed images are viewable by a user, and the user can then press the appropriate buttons for storing the images and speaking to the intruder.

13. The automotive security system of claim 11, further comprising a voice command preprogrammed to emanate from the camera car vocally informing anyone that he is being watched and recorded.
